(19) United States
(12) Patent Application Publication
(10) Pub. No.: US 2020/0080626 A1
(43) Pub. Date: Mar. 12, 2020

(54) REDUCTION OF NOISE, VIBRATION, AND HARSHNESS IN AN OPPOSED-PISTON ENGINE

(71) Applicant: ACHATES POWER, INC., San Diego, CA (US)

(72) Inventors: SUMANTH KASHYAP, San Diego, CA (US); ABHISHEK B. SAHASRABUDHE, Santa Clara, CA (US); JOHN M. KESSLER, San Diego, CA (US)

(73) Assignee: ACHATES POWER, INC., San Diego, CA (US)

(21) Appl. No.: 16/669,157

(22) Filed: Oct. 30, 2019

Related U.S. Application Data
(63) Continuation of application No. PCT/US2018/035605, filed on Jun. 1, 2018.
(60) Provisional application No. 62/514,366, filed on Jun. 2, 2017.

(51) Int. Cl. F16H 57/12; F02B 75/28; F16F 15/14; F16F 15/173; F16H 55/18; F16H 57/00

(52) U.S. Cl. CPC F16H 57/12; F02B 75/282; F16H 57/0006; F16F 15/173; F16H 55/18; F16F 15/145

(57) ABSTRACT

An opposed-piston engine includes at least two of: a gear train with a backlash reducing means; a viscous damper; and a centrifugal pendulum absorber. The opposed-piston engine can include two crankshafts and a gear train to connect the crankshafts. Any viscous dampers and centrifugal pendulum absorbers can be used to mitigate torsional velocity fluctuations in crankshafts in the engine, and multiple viscous dampers and/or centrifugal pendulum absorbers can be used in an engine. The backlash reducing means can include any of a means to adjust the position of gears in a gear train relative to each other and one or more backlash reducing gears.

### PRIORITY AND RELATED APPLICATIONS

This Application is a continuation of PCT application PCT/US2018/035605, filed Jun. 1, 2018, which claims priority to U.S. provisional application for patent U.S. 62/514,366, filed Jun. 2, 2017.

This application contains subject matter related to the subject matter of the following pending U.S. patent applications: U.S. application Ser. No. 15/176,818, filed 8 Jun. 2016, now U.S. Pat. No. 9,958,057; U.S. application Ser. No. 131385,539, filed Feb. 23, 2012 and published as U.S. 2012/0285422; U.S. application Ser. No. 13/858,943, filed Apr. 8, 2013, and published as U.S. 2014/0299109; U.S. application Ser. No. 13/944,787, filed Jul. 17, 2013, now U.S. Pat. No. 9,618,108: U.S. application Ser. No. 14/074,618, filed Nov. 7, 2013, and published as US 2015/0020629; U.S. application Ser. No. 14/450,747, filed Aug. 4, 2014, now U.S. Pat. No. 9,772,030; and U.S. application Ser. No. 15/142,261, filed Apr. 29, 2016, and published as U.S. 2017/0314646.

### FIELD

The field is reduction of noise, vibration, and harshness (NVH) in an internal combustion engine. More specifically, the field encompasses reduction of gear noise and vibration in the gear train of an opposed-piston engine through a combination of gear lash control and reduction of torsional vibrations of the crankshafts in the engine.

### BACKGROUND

Gear vibrations in an internal combustion engine can lead to intense whining, sharp impulse noise (e.g., rattle), or both. These noises can cause extreme operator and passenger discomfort in a vehicle. Engine whine and rattle also add to the constant cacophony that can make proximity to transportation routes unpleasant. Because of this, performance standards and environmental regulations relating to vehicles increasingly include NVH limits.

Backlash is a gap (e.g., lash) typically present in meshing gears to account for manufacturing tolerances, to prevent binding of gears at higher operating temperatures, and to account for other variations in gears that can exist during operation of an engine. In gear trains of opposed-piston engines, during torque reversals, the driving gear moves into contact with both flanks of the corresponding driven gear in a mesh, thereby producing gear rattle, especially when there is excessive backlash in the system.

The gear train of an opposed-piston engine with dual crankshafts inherently experiences events where contact is lost between teeth of adjacent gears in a mesh that produces rattle and vibration. For example, in the case where a phase difference is provided between the crankshafts (i.e., crank lead) in order to differentiate port opening and closing times, the gear train is subjected to a torque reversal event at least once every cycle of engine operation. Torque reversals result in gear train rattle when gear backlash is present.

Backlash control in an opposed-piston engine can involve a balance between noise control, minimization of friction loss, and efficient transfer of torque in the gear train. Conventional backlash controls include methods and apparatus that fix the backlash of an engine prior to operation of the engine (e.g., movement of idler gears, the use of select fit gears), or perhaps additionally after operation and alteration of an engine. Scissor gears of the conventional type, such as described in U.S. Pat. No. 5,979,259, are pre-tensioned with one or more torsional springs to take up the lash in a gear mesh between the scissor gear and an adjacent gear. Fluctuations in crankshaft torsional velocity of an opposed-piston engine can be mitigated, that is lessened or eliminated, by the use of a viscous damper, a centrifugal pendulum absorber, or a combination thereof. In an engine, minimization of noise, vibration, and harshness, backlash mitigation can be combined with crankshaft torsional velocity fluctuation reducing means.

### SUMMARY

A system and method for dynamic control of noise, vibration, and harshness in an opposed-piston engine with one or more crankshafts are provided in the embodiments described below. The noise, vibration, and losses caused by backlash and/or fluctuations in the crankshaft torsional velocity during operation of the engine can be mitigated by combining at least two of a backlash reducing device (e.g., a scissor gear or other anti-backlash device), a centrifugal pendulum absorber, and a viscous damper.

Some implementations are directed to an opposed-piston internal combustion engine that includes a gear train with an arrangement of gears coupling at least one crankshaft to an output drive and two or more of a backlash reducing gear in the gear train, a centrifugal pendulum absorber on the at least one crankshaft, and a viscous damper on the at least one crankshaft.

In a related aspect, some implementations provide an opposed-piston internal combustion engine that includes a gear train with an arrangement of gears coupling at least one crankshaft to an output drive and a means for reducing backlash and/or a means for crankshaft torsional velocity fluctuation mitigation.

The following features can be present in the opposed-piston internal combustion engine in any suitable combination. The means for crankshaft torsional velocity fluctuation mitigation can include a viscous damper, a centrifugal pendulum absorber, or any equivalent. In some implementations, the means for crankshaft torsional velocity fluctuation mitigation can include both a viscous damper and a centrifugal pendulum absorber. The engine can include a first and a second crankshaft, in which the gear train includes a first crank gear attached to the first crankshaft and a second crank gear attached to the second crankshaft, at least one idler gear, and a power take-off gear. The means for reducing backlash can include a positioning mechanism, a scissor gear, or any equivalent thereof. In some aspects, the scissor gear can have two or three gears in a gear assembly. In such aspects, the scissor gear can include any of a biasing spring, a roller clutch, and a hydraulic biasing means. Alternatively, or additionally, the backlash reducing means can include the at least one idler gear.

In a further related aspect, a method of reducing noise, vibration, and harshness in an opposed-piston engine is provided in some implementations. The method can include reducing rattle in a gear train using a backlash reducing means and damping crankshaft torsional velocity fluctuation during operation of the opposed-piston internal combustion engine. In some implementations, the method can include engaging the backlash reducing means upon start-up of the opposed-piston internal combustion engine.

### BRIEF DESCRIPTION OF THE DRAWINGS

FIG. 1 is a side elevation view of an arrangement of cylinders, pistons, and a gear train in an opposed-piston engine.

FIGS. 2A and 2B show side perspective elevational views of a schematic of an embodiment for an opposed-piston engine that includes viscous dampers and centrifugal pendulum absorbers.

FIG. 3 shows a cut-away view of an embodiment of a viscous damper for use in an opposed-piston engine.

FIG. 4A shows an embodiment of a centrifugal pendulum absorber for use in an opposed-piston engine.

FIG. 4B shows an exploded view of an exemplary absorber mass assembly for use with the centrifugal pendulum absorber shown in FIG. 4A.

FIG. 4C shows an embodiment of a centrifugal pendulum absorber for use in an opposed-piston engine.

FIG. 4D shows an exploded view of an exemplary absorber mass assembly for use with the centrifugal pendulum absorber shown in FIG. 4C.

FIG. 5 shows an exemplary backlash reducing gear for use in an opposed-piston engine.

FIG. 6 shows an embodiment of a gear train for use in an opposed-piston engine.

FIG. 7 is a cross-sectional view of the gear train shown in FIG. 6.

FIG. 8 shows a method for reducing noise, vibration, and harshness in an opposed-piston engine.

### DETAILED DESCRIPTION OF THE PREFERRED EMBODIMENTS

A specialized gear, system, and method for dynamic control of backlash in an opposed-piston engine are described. Using a backlash reducing gear, the amount of backlash between at least two adjacent gears in a gear train can be reduced, and at the same time noise and rattling resulting from loss of contact between the teeth of adjacent gears (due to, e.g., systemic torque reversals) can be damped during operation of the engine. While the engine is operating, adjustments to the backlash between at least two adjacent gears can be continuous and in response to changes in the engine such as temperature or wear.

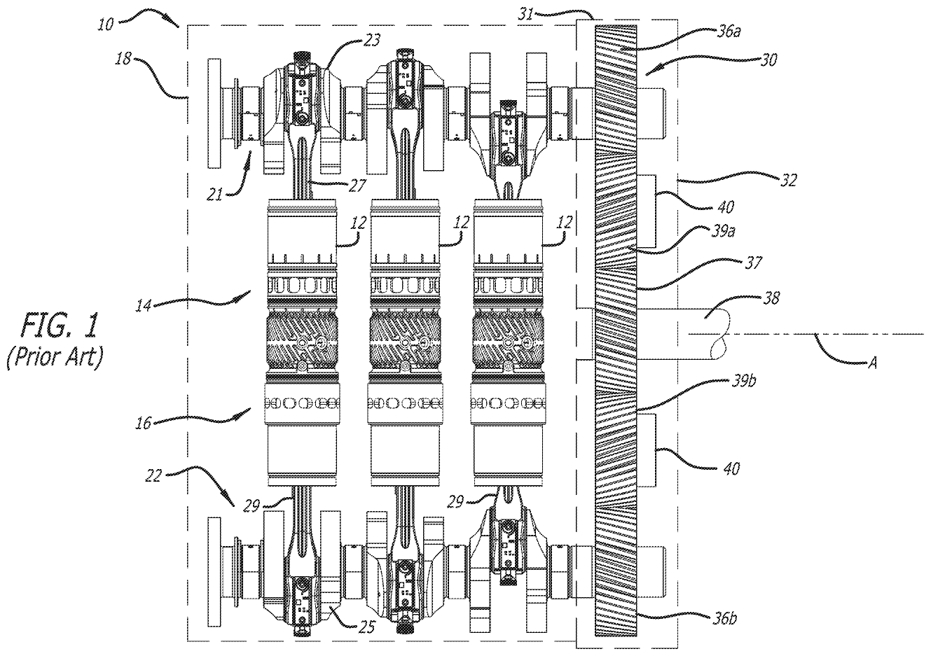

FIG. 1 illustrates an arrangement of cylinders, pistons, and crankshafts in an opposed-piston engine with an associated gear train that can include a backlash reducing gear. The figure shows a three-cylinder arrangement, although this is not intended to be limiting; in fact, the basic architecture portrayed in FIG. 1 is applicable to opposed-piston engines with fewer, or more, cylinders. The opposed-piston engine 10 includes cylinders 12, each including exhaust and intake ports 14 and 16. Preferably, the cylinders comprise liners that are fixedly mounted in tunnels formed in an engine frame or block 18. A pair of pistons (unseen in this figure) is disposed for opposing reciprocal movement in the bore of each cylinder 12. The opposed-piston engine 10 includes an interlinked crankshaft system comprising two rotatably-mounted crankshafts 21 and 22 and a crankshaft gear train 30 linking the crankshafts and coupling them to a power take-off shaft (“PTO shaft”). The crankshafts 21 and 22 are mounted to the engine by main bearing arrangements (not shown), one at the bottom of the engine block 18 and the other at the top. The crankshaft gear train 30 is supported in one end of the engine block 18 and is contained in a compartment 31 therein that is accessed through a removable cover 32.

As per FIG. 1, one piston of each piston pair is coupled to a respective crank journal 23 of the crankshaft 21 (i.e., exhaust end crankshaft) by a connecting rod assembly 27; the other piston is coupled to a respective crank journal 25 of the crankshaft 22 (i.e., intake end crankshaft) by a connecting rod assembly 29. The crankshafts 21 and 22 are disposed with their longitudinal axes in a spaced-apart, parallel arrangement. The crankshaft gear train 30 includes a plurality of gears, including two input gears 36a and 36b, which are fixed to respective ends of the crankshafts 21 and 22 for rotation therewith. An output gear 37 is mounted for rotation on a shaft or post. The output gear 37 drives a power take-off shaft 38 about an output axis of rotation A. In this configuration, two idler gears 39a and 39b are provided, each mounted for rotation on a fixed shaft or post 40. The idler gear 39a meshes with the input gear 36a and the output gear 37; the idler gear 39b meshes with the input gear 36b and the output gear 37. As a result of the configuration of the crankshaft gear train 30, the crankshafts 21 and 22 are co-rotating, that is to say, they rotate in the same direction. However, this is not meant to so limit the scope of this disclosure. In fact, a gear train construction according to this specification may have fewer, or more, gears, and may have counter-rotating crankshafts. Thus, although five gears are shown for the crankshaft gear train 30, the numbers and types of gears for any particular crankshaft gear train are dictated only by the engine design. For example, the crankshaft gear train 30 may comprise one idler gear for counter-rotation, or two idler gears (as shown) for co-rotation. Similarly, the power take-off shaft can be connected to one of the crank gears.

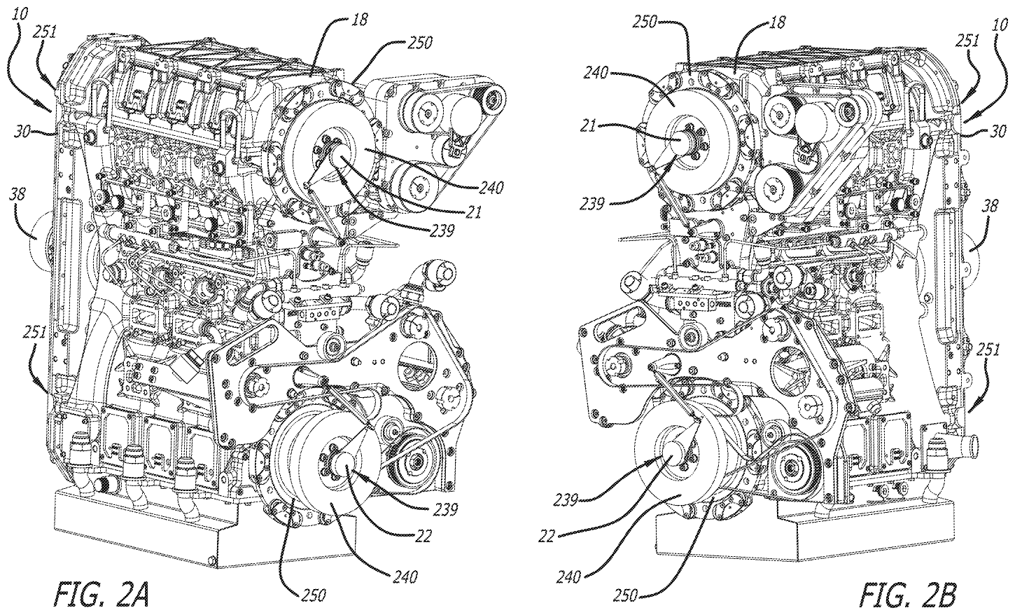

FIGS. 2A and 2B show two perspective views of an embodiment of a combination of viscous dampers 240 and centrifugal pendulum absorbers 250 for use with an opposed-piston engine 10. In the engine 10, there is an engine block 18, surrounding three cylinders (not shown), crankshafts 21 and 22, and a gear train 30 encased by a gear train cover. The gear train 30 can include a crank gear for each crankshaft, one or more idler gears, and a power take-off gear. The power take-off gear can attach to a corresponding power take-off shaft 38 that in turn attaches to a transmission (not shown). The engine 10 includes a viscous damper 240 and a centrifugal pendulum absorber 250 at the end of each crankshaft 21 and 22.

The engine 10 can combine the viscous dampers 240 and centrifugal pendulum absorbers 250 to reduce or mitigate any fluctuations in the crankshaft speed (i.e., torsional velocity) when the engine 10 is operating. Additionally, the engine 10 may include a means for reducing backlash, or anti-backlash means, in the gear train 30, like a scissor gear backlash reducing means or a gear positioning backlash reducing mechanism.

Though the opposed-piston engine 10 shown in FIGS. 2A and 2B has means for mitigating torsional vibration (e.g., torsional vibration mitigating means including viscous dampers 240 and/or centrifugal pendulum absorbers 250) only on crankshafts, and particularly on the nose ends 239, the viscous dampers 240 and/or centrifugal pendulum absorbers 250 may be placed on either the nose 239 or the tail end 251 of any crankshaft, or on both the nose 239 and tail 251 ends of any crankshaft. When any torsional vibration mitigating means is used at the nose 239 of a crankshaft, the torsional vibration mitigating means can be in adjacent to a front end accessory drive (i.e., FEAD). When any torsional vibration mitigating means is used at the tail 251 of a crankshaft, the torsional vibration mitigating means can be between the crankshaft and gear train or on the free end of the crankshaft, beyond the gear train. Further, in the torsional vibration mitigating means can be used with the posts supporting the idler gears or the power take-off shaft 38, at the nose 239, tail 251, or both the nose and tail of these posts or shaft. With respect to FIGS. 2A and 2B, the tail end 251 of any shaft is the end on the same side of the engine 10 as the main power take-off shaft 38 and gear, while the nose end 239 is that on the opposite side of the engine 10 as the power take-off shaft 38.

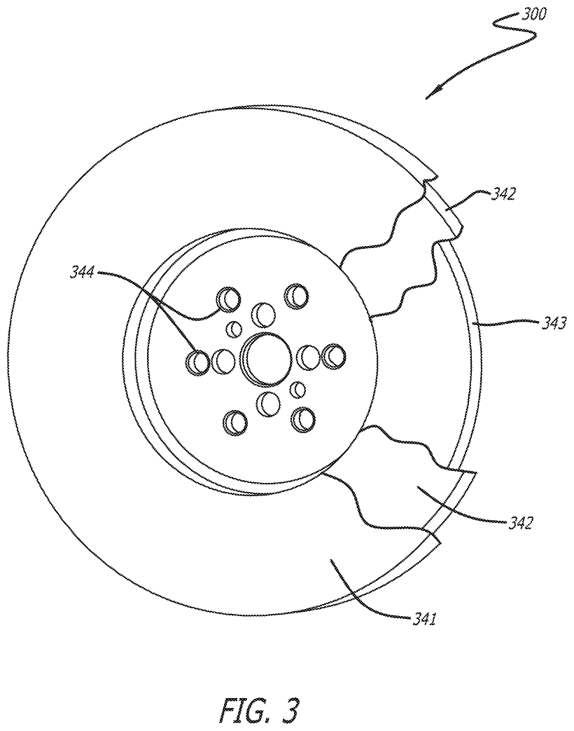

FIG. 3 shows a cut away view of an example of a viscous damper 300 compatible with an opposed-piston engine. The viscous damper 300 includes a housing 341 that surrounds a viscous fluid 342 and a machined inertial ring 343. Fittings 344 for attaching the viscous damper 300 to a crankshaft are on the inner part of the housing 341. The viscous damper 300 is able to damp a broad range of frequencies occurring in the engine. However, a disadvantage of viscous dampers is that they convert vibrational energy to heat. The heat generated by the dampers when mitigating vibrations in the engine may need to be actively dissipated (e.g., using cooling) or suitable materials may be selected to withstand the heat generated.

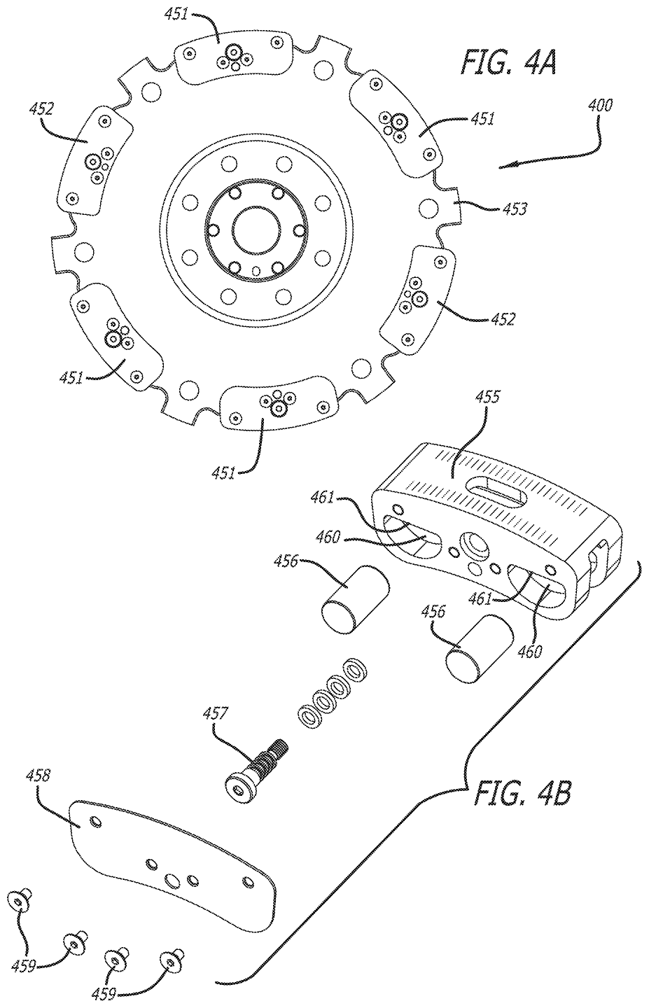

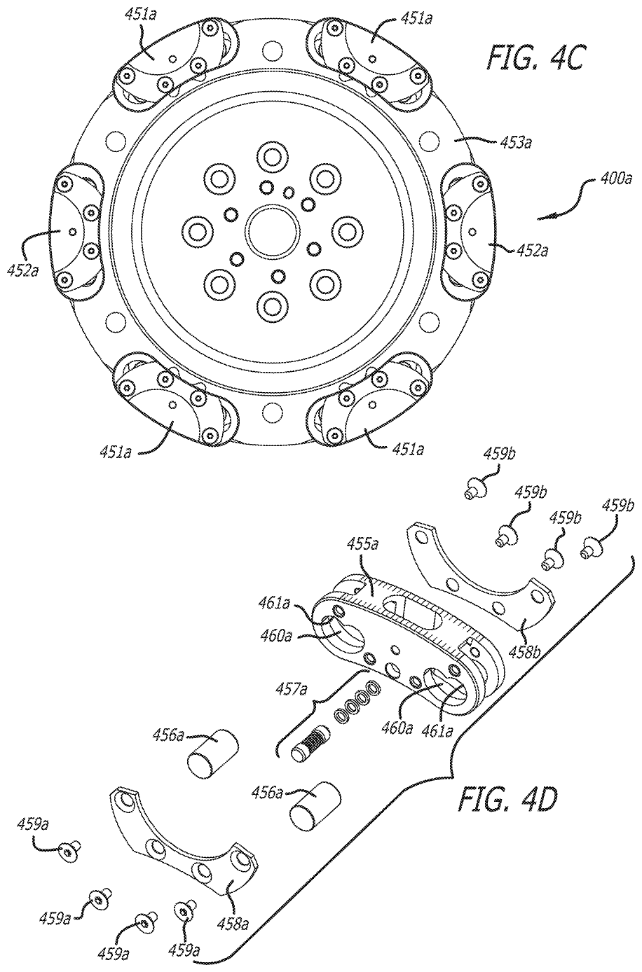

FIG. 4A shows a centrifugal pendulum absorber 400 for use with an opposed-piston engine. In FIG. 4A, the centrifugal pendulum absorber 400 has four third-order absorber mass assemblies 451, two sixth-order absorber mass assemblies 452, and a flange 453. FIG. 4B is an exploded view of an exemplary absorber mass assembly for use with the centrifugal pendulum absorber shown in FIG. 4A. Each assembly includes a mass 455, two rollers 456, a snubber assembly 457, a cover 458, and fittings 459. In the absorber mass assembly, the snubber assembly 457 attaches the mass 455 to the flange 453, while the fittings 459 attach the cover 458 to the mass 455. The mass 455 has a pair of openings 460 into which the rollers 456 fit. The shape of each opening 460, including the top portion 461 and rounded bottom, helps to guide the motion of the mass 455 relative to the flange 453a to counteract vibrations generated by the engine.

When the engine is in use, the motion of each mass 455 about the rollers 456 act in conjunction with the motion of the other masses 455 to reduce the amplitude of torsional vibrations. In some implementations, a centrifugal pendulum absorber 400 can be configured to reduce the amplitude of an entire order of vibrations. Further, a centrifugal pendulum absorber can be designed to be effective at an order corresponding to a dominant firing order in the engine. Alternatively, in the case of an opposed-piston engine with two crankshafts and a phase difference between exhaust pistons and intake pistons (e.g., crank lead) a centrifugal pendulum absorber can be designed to be effective at two or more dominant orders including the firing order, n, and an additional order, 2n. As is known in the art, a centrifugal pendulum absorber can be tailored to address various orders of vibration by having different pendulum inertia and paths (e.g., circular, cycloidal, epicycloidal, or tautochronic paths) for each order.

FIG. 4C shows another configuration of a centrifugal pendulum absorber 400a for use with an opposed-piston engine. In FIG. 4C, the centrifugal pendulum absorber 400a has four third-order absorber mass assemblies 451a, two sixth-order absorber mass assemblies 452a, and a flange 453a, similar to the centrifugal pendulum absorber shown in FIG. 4A. FIG. 4D is an exploded view of an exemplary absorber mass assembly for use with the centrifugal pendulum absorber shown in FIG. 4C. The shown assembly includes a mass 455a with a pair of openings 460a, two rollers 456a, a snubber assembly 457a, a first cover 458a, a second cover 458b, and fittings 459a and 459b. The snubber assembly 457a attaches the mass 455a to the flange 453a, while the fittings 459a attach the first cover 458a to a first face of the mass 455 and the fittings 459b attach the second cover 458b to another face, opposite to the first face, on the mass 455a. The rollers 456a are located in the openings 460a when the mass is assembled. The shape of each opening 460a, including the top portion 461a and rounded bottom, helps to guide the motion of the mass 455a relative to the flange 453a to counteract vibrations generated by the engine. In the mass assembly shown in FIG. 4D, the top portion 461a of each of the openings 461a is not flat, but rounded so that the over-all shape of each opening 461a is kidney-shaped or bean-shaped.

In some implementations, when an opposed-piston engine has more than one crankshaft (e.g., two crankshafts) the torques and vibrational modes experienced during engine operation can differ at each crankshaft. In such engines, a combination of a damping means (e.g., a viscous damper) and an absorber means (i.e., a centrifugal pendulum absorber) can be used for each crankshaft. Alternatively, some crankshafts can use a combination of a damping means and an absorber means, while one or more other crankshafts in the opposed-piston engine can use multiple damping means or multiple absorber means to mitigate torsional vibrations.

In use, a gear train of an engine can have a backlash reducing means. The backlash reducing means can include at least one backlash reducing gear adjacent to a mating gear. The backlash reducing gear can be any of a crank gear, idler gear, or drive gear. Other types of backlash reducing means, besides a backlash reducing gear, can include measures to adjust positions of gears relative to each other (e.g., a positioning mechanism) or adjust tensioning, finding a balance between increased friction and reduced center-to-center distance between adjacent gears. Some backlash reducing means can engage when the opposed-piston engine starts up. Alternatively, the backlash reducing means can be selectively engaged or always engaged.

A backlash reducing gear can have a first and a second gear which have approximately the same diameter and teeth on each gear in a gear assembly. The first and second gears of the backlash reducing gear can move relative each to other so that the width of the effective gear tooth made by the first and second gear increases or decreases, as needed. The teeth of an adjacent mating gear exert a reaction force on the teeth of the first and second gear of the backlash reducing gear. That reaction force is countered by the biasing mechanism within the backlash reducing gear (e.g., biasing spring, hydraulic biasing means).

One type of backlash reducing gear is a scissor gear. A scissor gear can have two or more gears, each with teeth. In a scissor gear, each gear is tensioned to a default position with respect to each other using any of a snap ring, multiple biasing springs, and hydraulically biased scissor gears. When the backlash reducing gear is in a first, biased position, the effective tooth thickness (e.g., width of a gear tooth) can be equivalent to that of a tooth with a width from each of the first gear and the second gear.

In use, the scissor gear is placed next to a mating gear. The teeth of the mating gear can be sufficiently close together (e.g., have a sufficient circular pitch), so that the first and second gears of the scissor gear will need to be rotated to allow for a meshing of the gear teeth. During engine operation, as the spacing of the teeth of the mating gear reduces (e.g., the tooth width of the mating gear expand), the effective width of the teeth of the scissor gear will reduce, so that the outside of the teeth of the first and second gears move closer together. The first and second gears of the scissor gear will remain tensioned so that the effective tooth thickness maintains close contact with the mating gear. In this way, the scissor gear prevents lash from forming between itself and the mating gear.

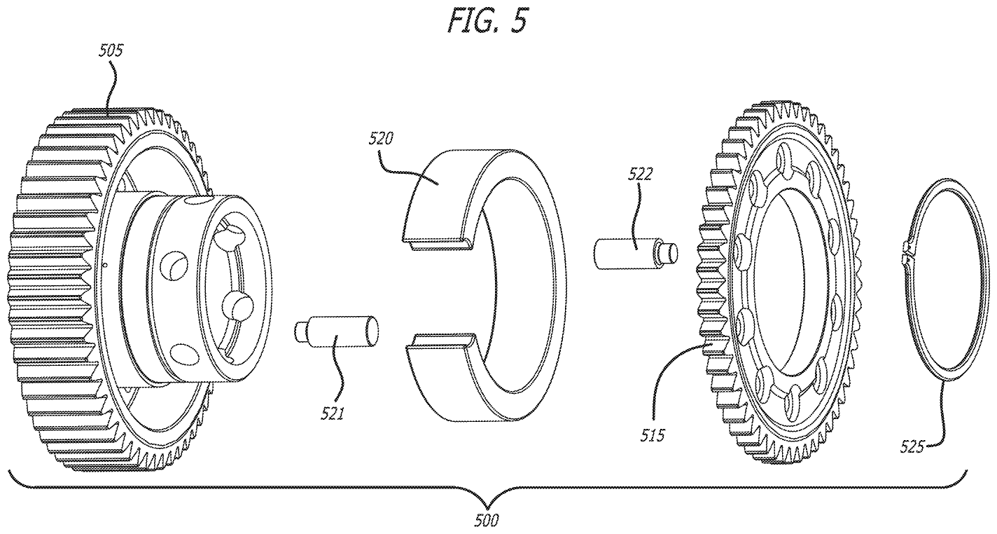

FIG. 5 shows a backlash reducing gear 500 for use with an opposed-piston engine. The backlash reducing gear 500 includes a first gear 505, a second gear 515, a torsion ring 520, a snap ring 525, a first locking pin 521 and a second locking pin 522. The first gear 505 shown in FIG. 5 is a performance gear or layer which bears the brunt of the load when transferring torque between this gear 500 and an adjacent, meshing gear. The second gear 515 in the backlash reducing gear 500 is a backlash taking-up gear. That is to say that the second gear 515 is a gear which is urged in a direction which creates an effective tooth width in the gear 500 that reduces or eliminates backlash between the gear 500 and a meshing gear. In the backlash reducing gear 500 shown in FIG. 5, the torsion ring 520 applies a force that urges the second gear 515 to rotate relative to the first gear 505 so that the effective gear tooth reduces backlash. The first locking pin 521 anchors a first end of the torsion ring 520 to the first gear 505, and the second locking pin 522 anchors a second end of the torsion ring 520 to the second gear 515. The snap ring 525 holds the assembly of the first gear 505, second gear 515, torsion ring 520, and the first and second locking pins 521 and 522 together in the backlash reducing gear 500.

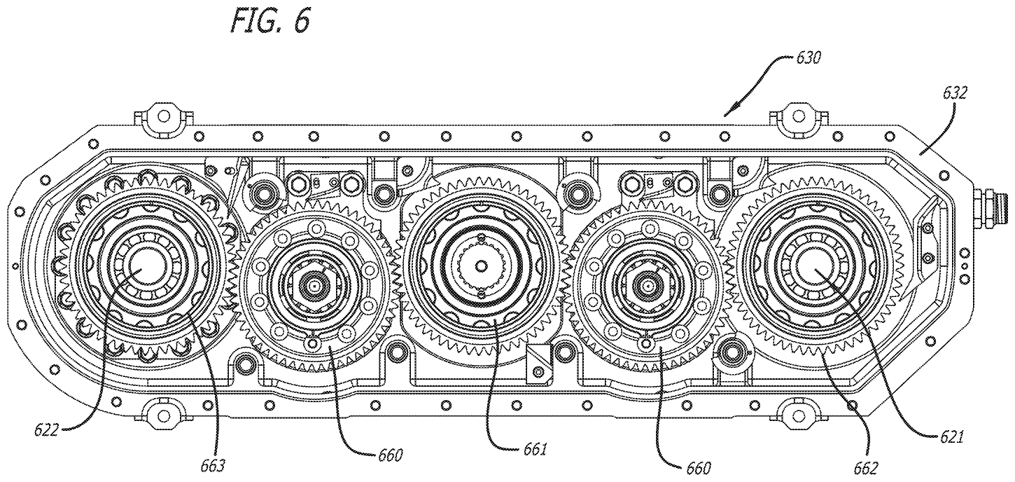

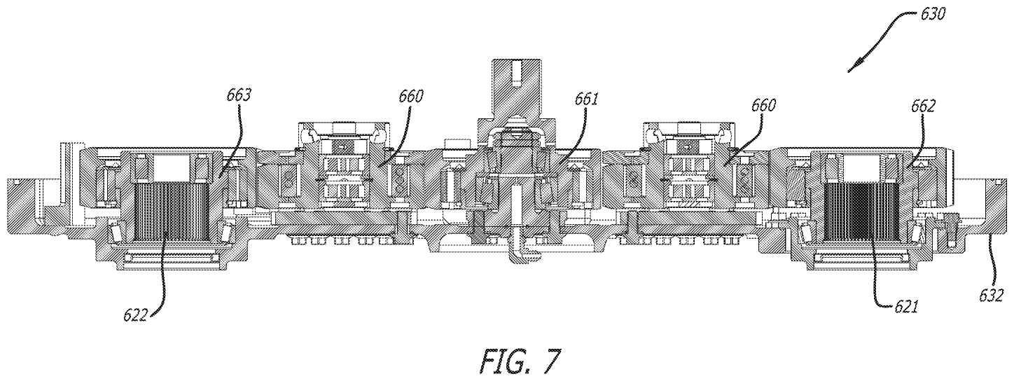

FIG. 6 is a side elevation view of a gear train 630 that includes idler gears 660 that are backlash reducing gears. FIG. 7 is a cross-sectional view of the gear train 630 shown in FIG. 6. In these figures, the gear train 630 is surrounded by a gear train cover 632, and the gear train 630 includes idler gears 660, a power take-off gear 661, a first crank gear 662, and a second crank gear 663. In the engine, there is a first crankshaft 621 connected to the first crank gear 662 and a second crankshaft 622 connected to the second crank gear 663. The idler gears 660 shown in FIGS. 6 and 7 are located adjacent to the first and second crank gears 662 and 663. The power take-off gear 661 is shown at the center of the gear train 630. The gear train 630 includes backlash reducing gears in the idler gear 660 positions. These backlash reducing idler gears 660 are shown as scissor gears with two gear parts: a primary gear and a backlash reducing secondary gear, as shown in FIG. 5.

However, the location of the backlash reducing gears in the idler gear positions 660 in the gear train 630 allows each backlash reducing gear to adapt only to the smallest amount of backlash in each gear mesh. For example, an idler gear with a primary gear and a secondary gear in the gear assembly will yield an effective tooth width that accommodates either the adjacent power take-off gear 661 or the adjacent crank gear 662 or 663. In some implementations, a backlash reducing gear can include a gear assembly with three gears, a first, second, and third gear. Such a backlash reducing gear can accommodate two adjacent gears with fixed teeth spacing or fixed center distance. A gear that can accommodate two adjacent gears is described in greater detail in U.S. Pat. No. 9,958,057, “Gear Backlash Control for an Opposed-Piston Engine,” issued May 1, 2018, or U.S. Pre-Grant publication US 2004/0089089 (published May 13, 2004 by Stevens et al.).

In an opposed-piston engine, a backlash reducing means (e.g., one or more backlash reducing gears, a positioning mechanism) can be used with a means for mitigating crankshaft torsional velocity fluctuations or torsional vibration (e.g., a viscous damper, a centrifugal pendulum absorber). The backlash reducing means can be used in the engine gear train, while the crankshaft torsional velocity fluctuation mitigating means can be applied to one or more crankshafts, typically at the end of a crankshaft. If more than one crankshaft is present in the engine, each crankshaft can have crankshaft torsional velocity fluctuation mitigating means attached to it which address the specific modes of vibration and velocity fluctuation for that crankshaft.

A gear train, like the one shown in FIGS. 6 and 7, may include one or more backlash reducing gears, such as the backlash reducing gears with a first and second gear, as described above. The number of backlash reducing gears in the gear train 630 can correspond to each pair of adjacent gears including at least one backlash reducing gear. In a gear train, one possible arrangement of gears would have a backlash reducing gear in a first position, at the outside of the train, as an input gear (e.g., 662 or 663 in FIG. 6). In a gear train with five gears, as shown in FIG. 6, the middle gear (e.g., output gear 661) and the other input gear would also be backlash reducing gears, though one of the idler gears (e.g., 660 in FIG. 6) could also be a backlash reducing gear in this configuration. When a backlash reducing gear as described above is adjacent to two gears with fixed teeth thickness and circular pitch, then the teeth of the backlash reducing gear can adjust to suit the mesh with the smallest amount of lash. The fact that a backlash reducing gear with two adjacent gears with different fixed gear teeth spacing can only accommodate one of the gears signifies that there will still be backlash in the gear train, but perhaps not as much as there would be using only conventional gears of fixed teeth spacing. To remove all of the backlash in a gear train, the number of backlash reducing gears with a first and second gear in the gear train needed corresponds to the number of gear meshes in the train. That is, for a gear train of n gears, n-1 backlash reducing gears with a first and second gear are needed to remove the entire backlash.

A gear train of two or more gears (e.g., n gears) can have one or more backlash reducing gears, as described above. For example, a gear train of n gears, one gear can be a backlash reducing gear, n-1 gears can be backlash reducing gears, n-2 gears can be backlash reducing gears, up to n gears (i.e., all the gears in the train) can be backlash reducing gears. The backlash reducing gears in a gear train can be all gears of a first and second gear or all backlash reducing gears can be gears with a first, second, and third gear, Alternatively, the backlash reducing gears in a gear train can be a combination of gears of a first and second gear and gears of a first, second, and third gear. Backlash reducing gears with a first, second, and third gear can accommodate two adjacent gears with different fixed gear teeth spacing. In some implementations, in a gear train, a single gear post can attach to two or more gears, such as at least one backlash reducing gear and one conventional gear, or to two or more backlash reducing gears. A gear post attached to two or more gears can allow the gear train to accommodate gears of multiple sizes (e.g., gears of multiple diameters).

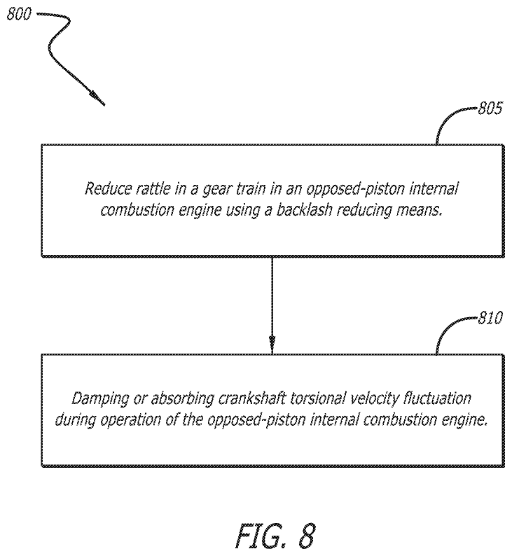

FIG. 8 shows a method 800 for reducing noise, vibration, and harshness in an opposed-piston internal combustion engine. In the method 800, rattle in a gear train in the engine is reduced using a backlash reducing means, as in 805. Mitigating crankshaft torsional velocity fluctuation during operation of the opposed-piston internal combustion engine, as in 810, can also be part of the method. In some implementations, one or more dampers, like viscous dampers, mitigate crankshaft torsional velocity fluctuations during engine operation. Alternatively, or additionally, one or more absorbers, such as centrifugal pendulum absorbers, can lessen crankshaft torsional velocity fluctuations while the engine is running. An opposed-piston engine may employ torsional vibration mitigating means (e.g., a viscous damper and/or a centrifugal pendulum absorber) without backlash reducing means (e.g., a scissor gear).

In the gear train of an engine, a backlash reducing gear as described herein can be placed adjacent to at least one other gear. The gear train can have three or more gears. For each pair of adjacent gears, at least one gear can be a backlash reducing gear to minimize backlash and allow the engine to better accommodate systematic torque reversals, reducing engine rattle.

The scope of patent protection afforded the novel tools and methods described and illustrated herein may suitably comprise, consist of, or consist essentially of the elements including an opposed-piston engine with at least two of a gear train with a backlash reducing means, a viscous damper, and a centrifugal pendulum absorber that allow for the reduction or elimination of noise, vibration, and/or harshness in the engine. Further, the novel tools and methods disclosed and illustrated herein may suitably be practiced in the absence of any element or step which is not specifically disclosed in the specification, illustrated in the drawings, and/or exemplified in the embodiments of this application. Moreover, although the invention has been described with reference to the presently preferred embodiment, it should be understood that various modifications can be made without departing from the spirit of the invention. Accordingly, the invention is limited only by the following claims.

What is claimed is:

1. An opposed-piston internal combustion engine comprising:
a gear train comprising an arrangement of gears coupling at least one crankshaft to an output drive; and
means for reducing backlash, means for crankshaft torsional velocity fluctuation mitigation, or both means for reducing backlash and means for crankshaft torsional velocity fluctuation mitigation.

2. The opposed-piston internal combustion engine of claim 1, wherein the means for crankshaft torsional velocity fluctuation mitigation comprises a viscous damper or a centrifugal pendulum absorber, with the means for crankshaft torsional velocity fluctuation mitigation on the at least one crankshaft.

3. The opposed-piston internal combustion engine of claim 1, wherein the means for crankshaft torsional velocity fluctuation mitigation comprises both a viscous damper and a centrifugal pendulum absorber, with the means for crankshaft torsional velocity fluctuation mitigation on the at least one crankshaft.

4. The opposed-piston internal combustion engine of either claim 2 or 3, wherein the engine comprises a first and a second crankshaft, further wherein the gear train comprises a first crank gear attached to the first crankshaft, a second crank gear attached to the second crankshaft, at least one idler gear, and a power take-off gear.

5. The opposed-piston internal combustion engine of claim 4, wherein the means for reducing backlash comprises a positioning mechanism or a scissor gear, the scissor gear comprising two or three gears in a gear assembly.

6. The opposed-piston internal combustion engine of claim 5, wherein the scissor gear comprises any of: a biasing spring, a roller clutch, and a hydraulic biasing means.

7. The opposed-piston internal combustion engine of any of claims 4-6, wherein the means for reducing backlash comprises the at least one idler gear. A method for reducing noise, harshness, and vibration in an opposed-piston internal combustion engine, the method comprising damping crankshaft torsional velocity fluctuation during operation of the opposed-piston internal combustion engine.

9. The method of claim 8, further comprising reducing rattle in a gear train using a means for reducing backlash.

10. The method of claim 9, further comprising engaging the means for reducing backlash upon start-up of the opposed-piston internal combustion engine.

11. The method of claim 9, wherein the means for reducing backlash comprise a positioning mechanism or a scissor gear, the scissor gear comprising two or three gears in a gear assembly.

12. The method of claim 11 wherein the scissor gear comprises any of: a biasing spring, a roller clutch, and a hydraulic biasing means.

13. The method of any of claims 8-12, wherein damping crankshaft torsional velocity fluctuation comprises including a viscous damper on a crankshaft in the opposed-piston engine.

14. An opposed-piston internal combustion engine, comprising:
a gear train comprising an arrangement of gears coupling at least one crankshaft to an output drive; and
a centrifugal pendulum absorber and a viscous damper on the at least one crankshaft.

15. The opposed-piston internal combustion engine of claim 14, further comprising a scissor gear in the gear train.

16. The opposed-piston internal combustion engine of claim 15, wherein the scissor gear comprises any of: a biasing spring, a roller clutch, and a hydraulic biasing means.

17. The opposed-piston internal combustion engine of claim 14, further comprising a means for reducing backlash that comprises a positioning mechanism.
